(19) United States
(12) Patent Application Publication
(10) Pub. No.: US 2024/0040955 A1
(43) Pub. Date: Feb. 8, 2024

(54) SINGLE-STEP SEED PLACEMENT IN FURROW AND RELATED DEVICES, SYSTEMS, AND METHODS

(71) Applicant: Ag Leader Technology, Ames, IA (US)

(72) Inventor: Alan F. Barry, Nevada, IA (US)

(21) Appl. No.: 18/230,534

(22) Filed: Aug. 4, 2023

Related U.S. Application Data
(60) Provisional application No. 63/395,061, filed on Aug. 4, 2022.

(51) Int. Cl. A01C 5/06; A01C 7/04; A01B 49/06

(52) U.S. Cl. CPC A01C 5/062; A01C 7/04; A01B 49/06

(57) ABSTRACT

A furrow opening and seed placement device configured to perform a planting sequence into one continuous action. The device comprising a substantially horizontal blade configured to be drawn through soil at a desired planting depth, an opening within the blade configured to allow seed to be deposited in soil below a bottom surface of the substantially horizontal blade, and one or more vertical elements configured to direct soil flow around the substantially horizontal blade.

### CROSS-REFERENCE TO RELATED APPLICATION(S)

This application claims the benefit under 35 U.S.C. § 119(e) to U.S. Provisional Application 63/395,061, filed Aug. 4, 2023, and entitled Seed Placement in Furrow, which is hereby incorporated herein by reference in its entirety for all purposes.

### TECHNICAL FIELD

The disclosure relates to agricultural planting systems, and related devices and methods.

### BACKGROUND

Current row crop planting technology performs each step in the planting process as a separate function. A furrow is formed by forcing a pair of discs into the soil to form the furrow. Gauge wheels located alongside the discs determine the depth of the furrow (seed placement depth) and also firm the soil so it can maintain the shape pressed into it until the seed is deposited. Dryer soils and sandier soils require more firming pressure than moist soil or soil with a lot of clay content. If the furrow is not formed properly or does not hold its shape long enough to allow the seed to be placed the result can be inconsistent planting depth, poor seed to soil contact, or seeds planted into dry soil resulting in reduced germination and reduced yield potential. Mechanical problems such as worn discs, improperly adjusted discs, or worn supporting parts can also affect the shape and structural integrity of the furrow.

After the furrow is formed, seed is placed in the furrow. It is critical that the seed falls to the bottom of the furrow for proper depth and the best chance of seed to soil contact to promote germination. The depth is typically set so there is moist soil at the bottom of the furrow. The horizontal and vertical velocity of the seed is an important factor in the seed reaching the desired location. If the seed is traveling too fast vertically it can bounce off the soil surface and land out of position. If the horizontal velocity is greater than the forward travel speed, the seed can roll rearward in the furrow disturbing the spacing with adjacent seeds. If the horizontal velocity is less than the forward travel speed, the seed can roll forward in the furrow disturbing the spacing with adjacent seeds. As would be appreciated, there are many factors that must be precisely controlled to accurately place individual seeds in the proper location and maintain proper seed spacing in the row.

With the seed placed in the furrow, the furrow needs to be closed to compress soil around the seed to promote germination and to eliminate the furrow wall compaction that was created as the furrow was formed. If not properly closed, the furrow surface can dry and open exposing seeds to the air resulting in reduced germination and lost yield potential. There is a need in the art for devices, systems, and methods for ensuring seeds are planted in moist soil, at the correct depth and spacing.

### BRIEF SUMMARY

Various implementations discussed herein relate to a furrow opener configured to open a trench in the soil for simultaneous placement of seed from a dispensing system. In these implementations, soil flow is manipulated such that the soil fills in around the seed while the seed is still in motion. Because the seed is surrounded by soil while in motion, the seed horizontal velocity does not need to be precisely controlled. The seed motion is dampened such that there is little to no possibility of bouncing or rolling that can effect spacing as seen in conventional seed placement systems. In the disclosed implementations, seed depth consistency is maintained by creating a funnel shape in the soil flow and directing the seed travel to the center of the funnel.

In Example 1, a furrow opening and seed placement device configured to perform a planting sequence in one continuous action, comprising a substantially planar blade configured to be drawn through soil at a desired planting depth, an opening within the substantially planar blade configured to allow seed to be deposited in soil below a bottom surface of the substantially planar blade, and one or more vertical elements configured to direct soil flow around the substantially planar blade.

Example 2 relates to the device of Example 1, wherein the substantially planar blade is pivotable between ±5° of a horizontal plane.

Example 3 relates to the device of any of Examples 1-2, further comprising a coulter disposed on a row unit in front of the furrow opening and seed placement device.

Example 4 relates to the device of any of Examples 1-3, further comprising a seed delivery device disposed above the opening within the substantially planar blade.

Example 5 relates to the device of any of Examples 1-4, wherein the seed delivery device is a conventional delivery tube or an air drive delivery device.

In Example 6, an agricultural row unit comprising a coulter and a furrow opening and seed placement device. The furrow opening and seed placement device comprising a substantially planar blade, an opening in the substantially planar blade shaped to allow passage of seed from a seed delivery device to soil below the substantially planar blade, and a vertical element connecting the substantially planar blade to the agricultural row unit, the vertical element shaped to direct soil flow about the furrow opening and seed placement device, wherein seed is placed in the furrow at the same time the furrow is formed.

Example 7 relates to the agricultural row unit of Example 6, wherein planting depth is an operating depth of the substantially planar blade.

Example 8 relates to the agricultural row unit of any of Examples 6-7, wherein the coulter operates at a depth below the planting depth.

Example 9 relates to the agricultural row unit of any of Example 6-8, wherein the coulter is arranged on the agricultural row unit to cut the soil just in front of the furrow opening and seed placement device.

Example 10 relates to the agricultural row unit of any of Examples 6-9, wherein where in the furrow opening and seed placement device creates a funnel like soil flow.

Example 11 relates to the agricultural row unit of any of Examples 6-10, wherein the substantially planar blade is pivotable between ±5° of a horizontal plane.

Example 12 relates to the agricultural row unit of any of Examples 6-11, wherein the substantially planar blade is pivotable on-the-go.

Example 13 relates to the agricultural row unit of any of Examples 6-12, wherein the seed delivery device is a conventional delivery tube or an air drive delivery device.

In Example 14. A method for planting seed, comprising cutting soil with a coulter blade, drawing a blade through soil to create a furrow, the blade comprising a substantially planar surface, at least one vertical element configured to direct soil flow, and an opening in the substantially planar surface, creating a soil funnel with the blade, and inserting a seed into the furrow by causing the seed to exit a seed delivery device, fall through the opening into a center of the soil funnel, and land in the furrow.

Example 15 relates to the method of Example 14, further comprising pivoting the blade at an angle ±5° of a horizontal plane.

Example 16 relates to the method of any of Examples 14-15, wherein the steps of creating a soil funnel and inserting a seed are executed simultaneously.

Example 17 relates to the method of any of Examples 14-16, wherein soil fall around the seed while the seed is inserting into the furrow such that the seed does not bounce or roll.

Example 18 relates to the method of any of Examples 14-17, wherein the soil funnel has a vortical flow.

Example 19 relates to the method of any of Example 14-15, wherein the blade is drawn through soil at a desired planting depth.

Example 20 relates to the method of any of Examples 14-19, wherein the coulter blade cuts the soil at a depth below the desired planting depth.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a side view of a row unit, according to one implementation.

FIG. 2 is a side view of a row unit, according to one implementation.

FIG. 3A is a side, perspective view of the sweep, according to one implementation.

FIG. 3B is a rear view of the sweep, according to one implementation.

FIG. 3C is a bottom view of the sweep, according to one implementation.

FIG. 4 is a schematic diagram of the soil profile during planting, according to one implementation.

FIG. 5 is a top-down view of a seed during planting, according to one implementation.

FIG. 6 is a top-down view of a seed during planting, according to one implementation.

FIG. 7 is a side view of a row unit implementing the system, according to one implementation.

### DETAILED DESCRIPTION

The disclosed planting system consolidates the individual activities—opening a furrow, placing a seed, and closing a furrow—in the planting sequence into one continuous action. Use of a sweep to create of soil vortex and placing the seed using the soil vortex accomplishes steps of planting a seed at a desired planting depth and location in a field.

The disclosed devices, and associated systems and methods execute planting in a single step rather than in a series of sequential steps. Additionally, the devices and associated systems and methods overcome the need in prior systems to precisely control a seeds horizontal and vertical velocities when existing the row unit/seed placement device to avoid bouncing and/or rolling that can disturb seed location and/or depth.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16,523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. patent application Ser. No. 17/225,740, filed Apr. 8, 2021, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,678, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/081,432, filed Dec. 14, 2022, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/215,721, filed Jun. 28, 2023, entitled “Seed Tube Guard and Associated Systems, Devices, and Methods of Use,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. Patent Application 63/400,943, filed Aug. 25, 2022, entitled “Combine Yield Monitor,” U.S. Patent Application 63/406,151, filed Sep. 13, 2022, entitled “Hopper Lid with Magnet Retention and Related Systems and Methods,” U.S. Patent Application 63/427,028, filed Nov. 21, 2022, entitled “Stalk Sensors and Associated Devices, Systems and Methods,” U.S. Patent Application 63/445,960, filed Feb. 15, 2023, entitled “Ear Shelling Detection and Related Devices, Systems, and Methods,” U.S. Patent Application 63/445,550, filed Feb. 14, 2023, entitled “Liquid Flow Meter and Flow Balancer,” U.S. Patent Application 63/466,144, filed May 12, 2023, entitled “Devices, Systems, and Methods for Providing Yield Maps,” U.S. Patent Application 63/466,560, filed May 15, 2023, entitled “Devices, Systems, and Methods for Agricultural Guidance and Navigation,” U.S. Patent Application 63/524,065, filed Jun. 29, 2023, entitled “Ring Assembly,” and U.S. Patent Application 63/525,525, filed Jul. 7, 2023, entitled “Assisted Steering Systems and Associated Devices and Methods for Agricultural Vehicles,” each of which is incorporated by reference herein.

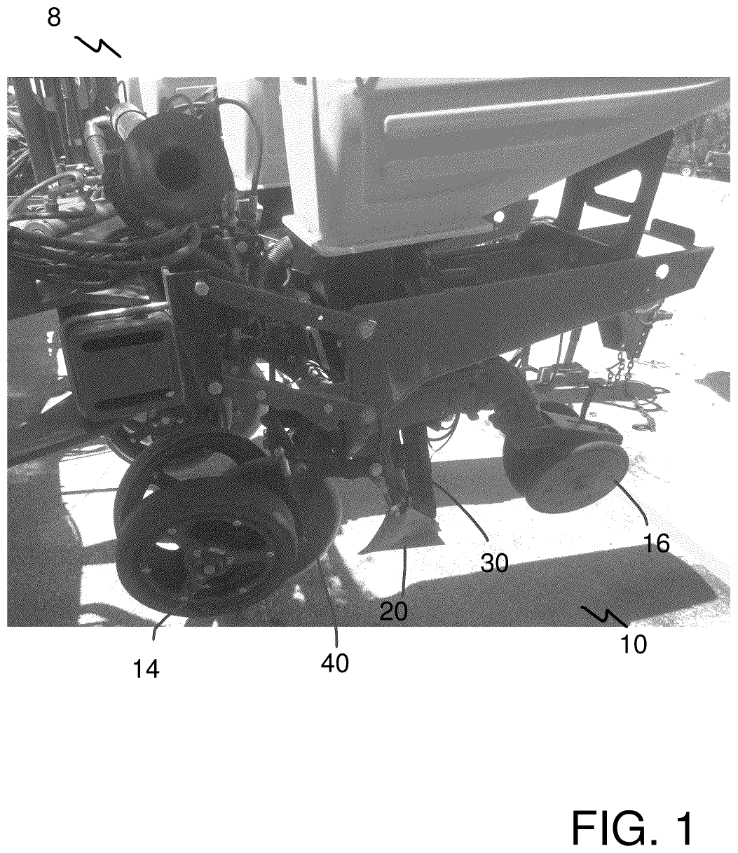

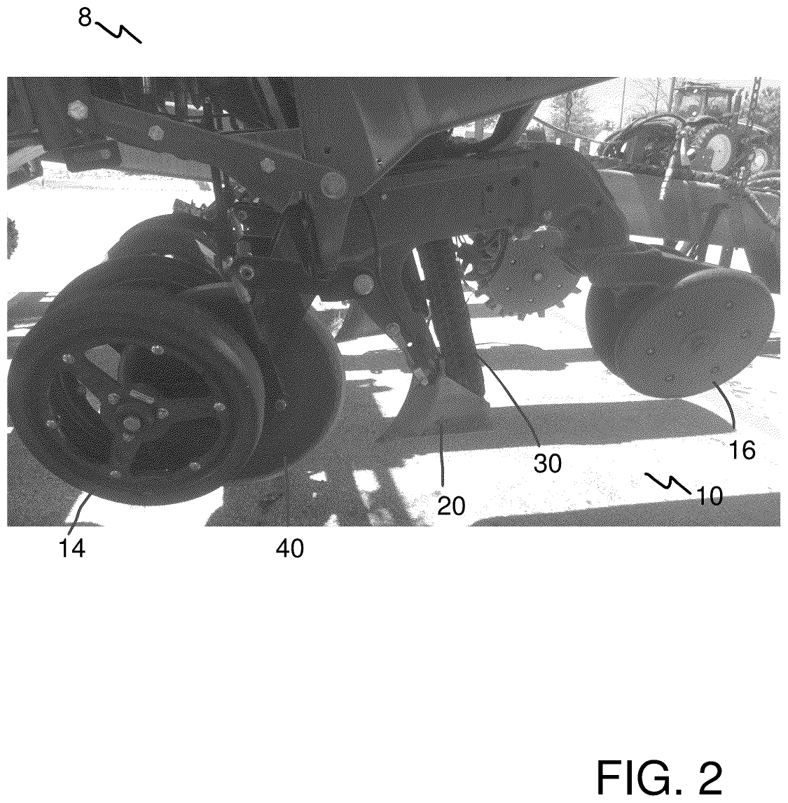

Turning to the figures in more detail, FIGS. 1-2 show a row unit 2 implementing the disclosed planting system 10. As would be appreciated planting row units 8 include a variety of components, and each row unit 8 across a planter are typically substantially identical, that is comprised of the same basic components. In various implementations, the row unit 8 with the system 10 include a sweep 20 and seed placement device 30. Further implementations include gauge wheels 14, a coulter 40, and closing discs 16. Various additional row unit 8 components may also be included and would be appreciated by those of skill in the art.

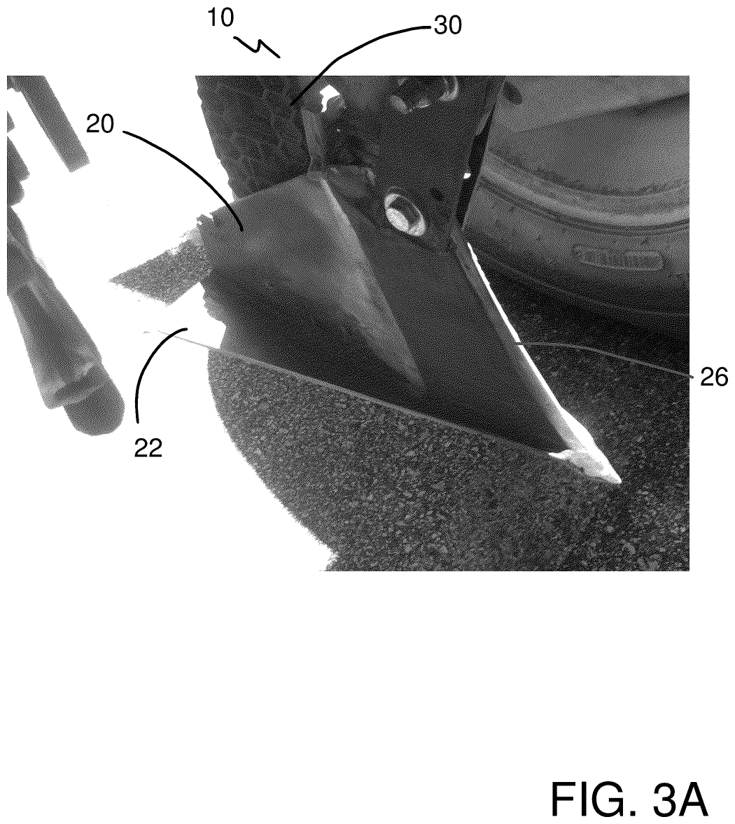

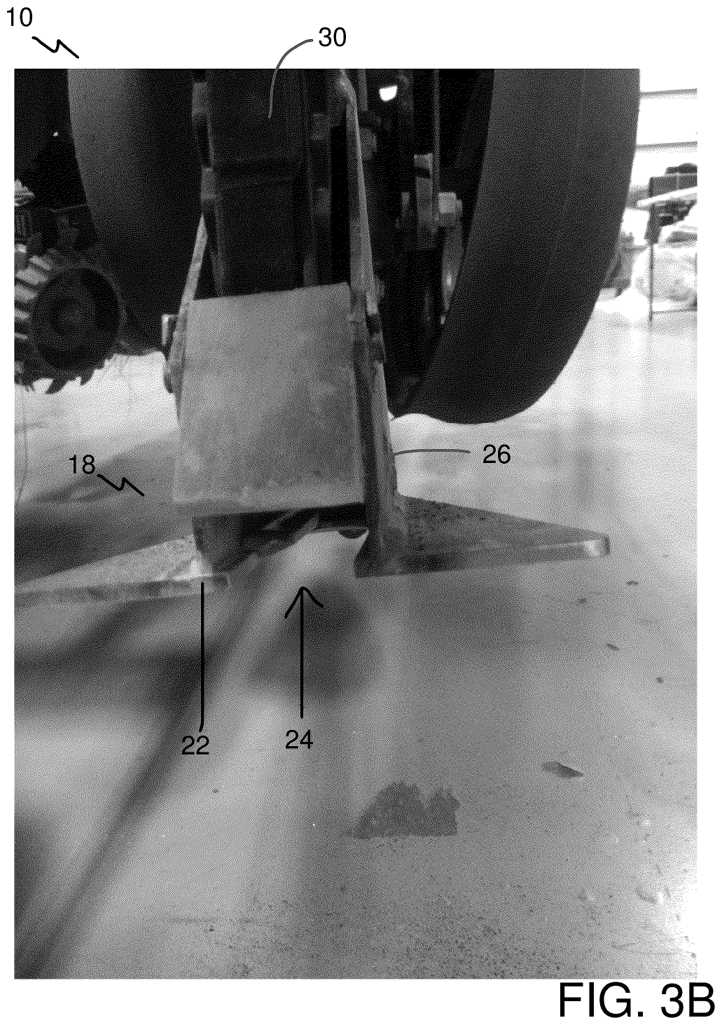

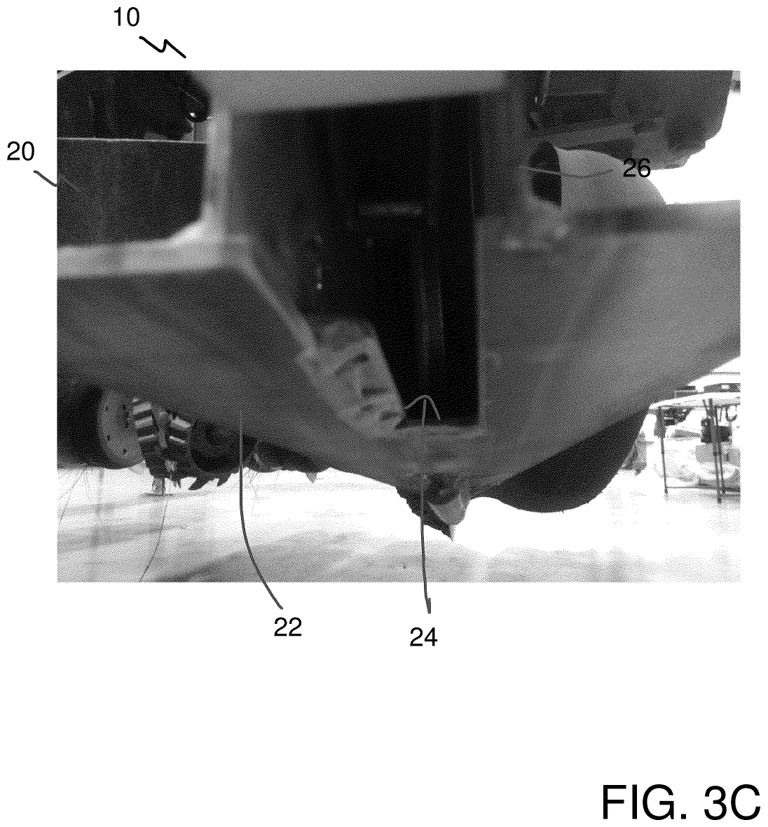

FIGS. 3A-3C show various views of the sweep 20 for use with a simultaneous planting system 10 according to certain implementations. The sweep 20 includes a horizontal blade 22 that is drawn through the soil at the desired planting depth. The blade 20 has a blade opening 24 configured to allow seed to be deposited in the soil below the bottom surface of the blade 22. In various implementations, vertical elements 26 on the sweep 20 direct the soil flow around the seed placement device 30 so the seed placement device is not disturbed by the flow of soil.

In these implementations, the combination of the horizontal blade 22 and the vertical elements 26 combine to lift the soil so seed can be placed under the sweep 20. The soil is then allowed to collapse back down on top of the seed. In these implementations, seed depth is not determined by the depth of the furrow previously formed; it is determined by the operating depth of the sweep 20.

In various implementations, the sweep 22 may have a pitch between about ±5° of horizontal with respect to the soil. The pitch of the sweep 22 may be adjusted/set in order to produce the soil flow needed for planting. In various implementations, the pitch of the sweep 22 may be adjusted manually, or alternatively may be adjusted via an actuator in communication with a control system, as would be understood. The pitch of the sweep 22 may optionally be adjusted on-the-go, or alternatively set prior to beginning planting operations.

It would be appreciated that because the seed is immediately engulfed in the flowing soil after dropping through the blade opening 24, there is far less possibility of spacing errors due to travel speed and/or depth control issues caused by seed bounce. Conventional gravity or positive air seed delivery systems 30 can be employed without the need for additional in-furrow seed trapping means such as seed firmers or rolling trap wheels. Because a conventional furrow is not formed ahead of placing the seed, there is no furrow compaction to disrupt to promote seed to soil contact.

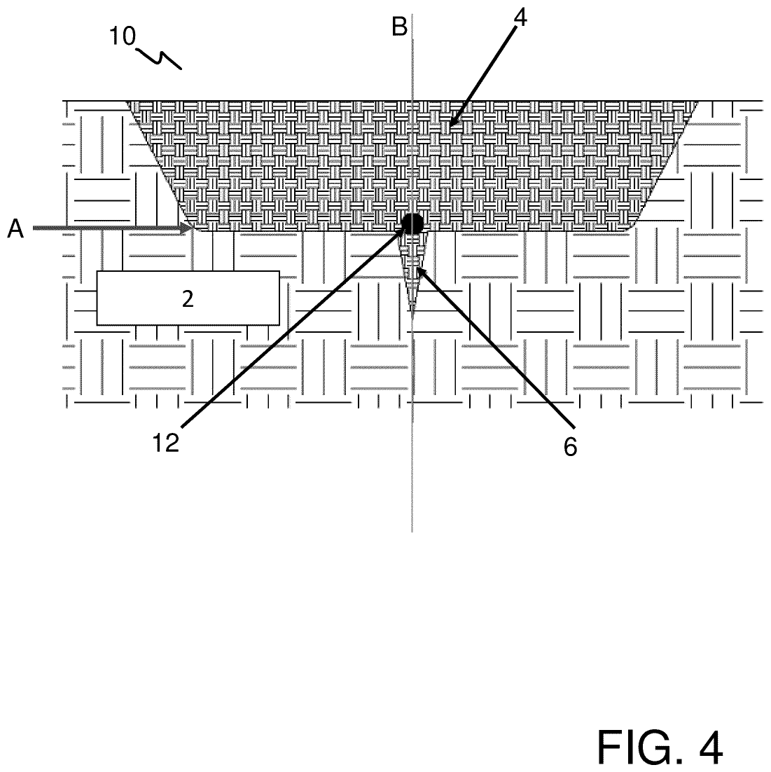

FIG. 4 shows a cross section of soil 2 during the planting process. As can be seen the majority of the soil 2 is undisturbed. The shape of the sweep 20 causes minimal disturbance in the soil 2 while placing the seed 12 below the soil surface at a desired planting depth (indicated at reference arrow A). The soil 2 is opened in a semi cone shaped funnel 4. The soil flow around the sweep 20 has no horizontal velocity. The movement in the soil is caused by the movement of the sweep 20 through the soil 2. The seed 12 is placed at the center of the funnel 4 to accurately place it at the desired depth.

In various implementations, ahead of the sweep 20, a rolling coulter 40 (shown in FIGS. 1 and 2) parts the soil 2 to assist the sweep 20 and the soil flow. The coulter 40 is positioned directly on the side-to-side centerline (shown at B) of the sweep 30. In various implementations, the coulter 40 depth—the lowest point of the blade 40—is below the operating depth of the sweep 20 horizontal knife 22 that establishes the planting depth (shown at reference arrow A), creating a small disturbed area 6 below the planting depth. In these and other implementations, the disturbed area 6 is not large enough for a seed 12 to fall below the desired planting depth (arrow A) but instead will rest above it.

As would be appreciated, the rolling coulter 40 parts the soil and cuts residue. This allows the residue to pass around the sweep 20 without catching and dragging which could lead to plugging problems.

The combination of the coulter 40 penetration and sweep 20 create a soil profile, shown in FIG. 4, that is conducive to seed germination and root development. Soil pushed aside by the coulter is filled by the passage of the sweep 20 but is not compacted as occurs with conventional “V” type opener disks and side mounted gauge wheels.

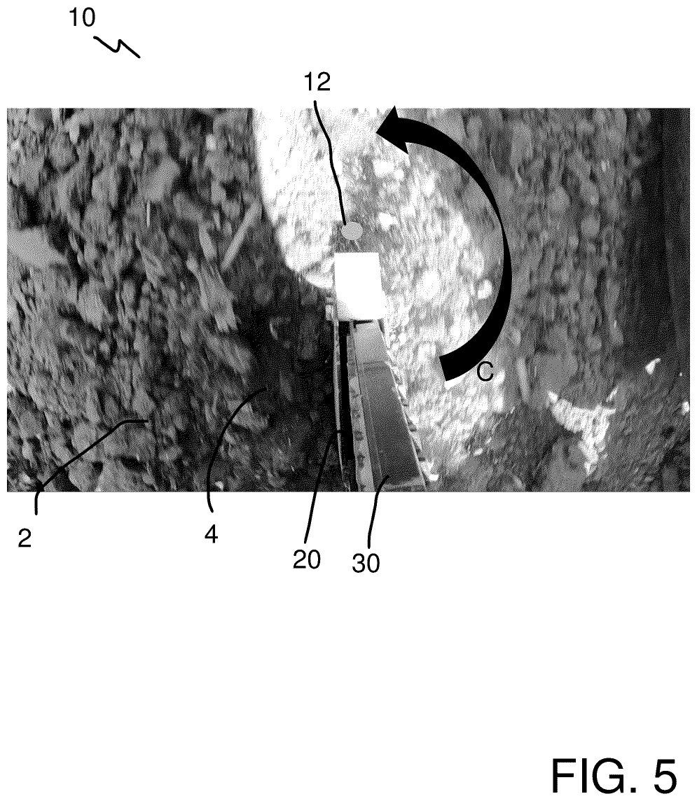

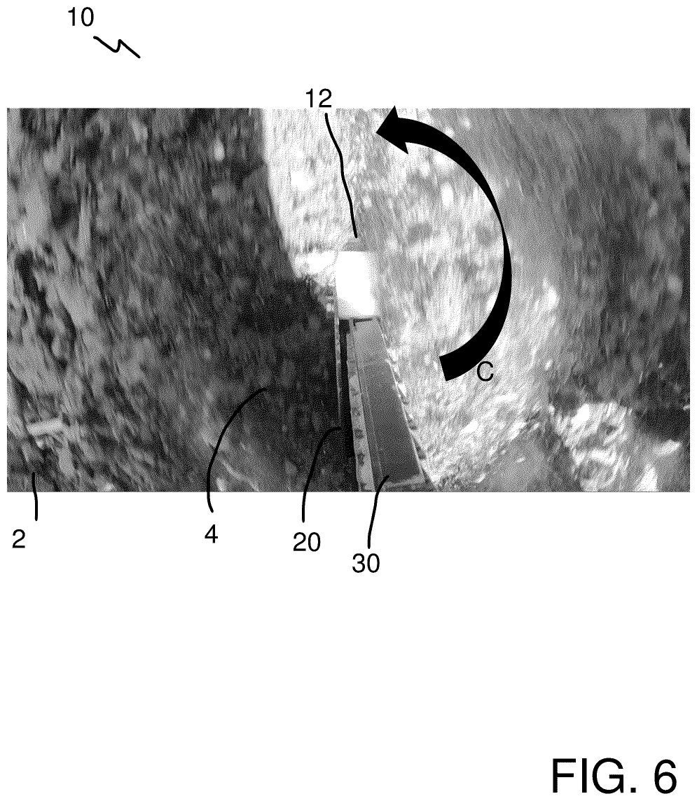

FIGS. 5 and 6 show top-down views of seed planting by certain implementations of the disclosed simultaneous planting system 10. In these and other implementations, the sweep 20 creates a vortex/funnel 4 in the soil 2 (rotating as shown by reference arrow C). The seed 12 then exits the seed delivery device 30 and is placed in the center of the funnel 4 and descends to the desired planting depth, which is the operating depth of the sweep 20. The seed 12 is engulfed in and surrounded by the soil 2 such that horizontal and vertical movement of the seed 12 is not a factor in influence ultimate seed placement.

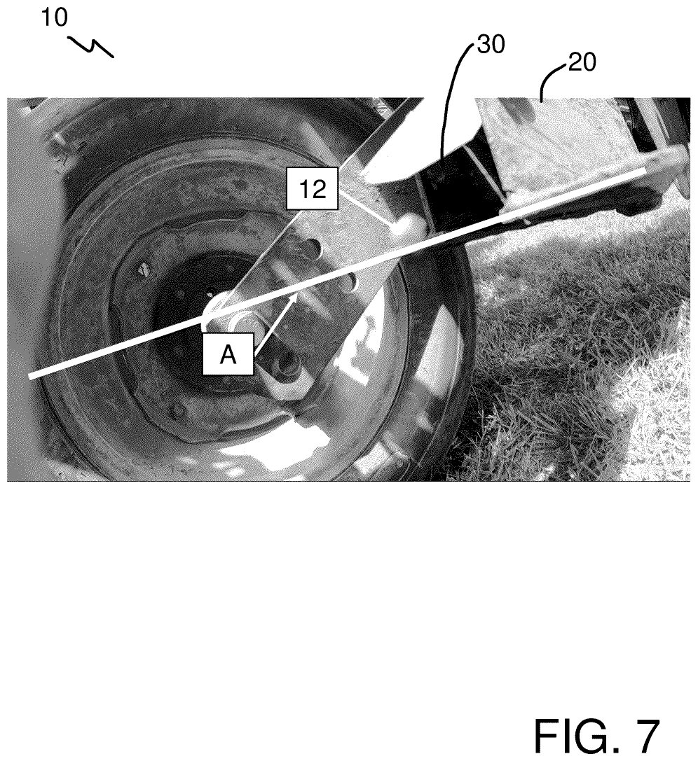

FIG. 7 shows an alternative side view of the simultaneous planting system 10 in operation. In this implementation, the seed 12 exits the seed delivery device 30 and is deposited at the operating depth (arrow A) of the sweep 20.

Although the disclosure has been described with references to various embodiments, persons skilled in the art will recognize that changes may be made in form and detail without departing from the spirit and scope of this disclosure.

What is claimed is:

1. A furrow opening and seed placement device configured to perform a planting sequence in one continuous action, comprising:
(a) a substantially planar blade configured to be drawn through soil at a desired planting depth;
(b) an opening within the substantially planar blade configured to allow seed to be deposited in soil below a bottom surface of the substantially planar blade; and
(c) one or more vertical elements configured to direct soil flow around the substantially planar blade.

2. The device of claim 1, wherein the substantially planar blade is pivotable between ±5° of a horizontal plane.

3. The device of claim 1, further comprising a coulter disposed on a row unit in front of the furrow opening and seed placement device.

4. The device of claim 1, further comprising a seed delivery device disposed above the opening within the substantially planar blade.

5. The device of claim 4, wherein the seed delivery device is a conventional delivery tube or an air drive delivery device.

6. An agricultural row unit comprising:
(a) a coulter; and
(b) a furrow opening and seed placement device comprising:
(i) a substantially planar blade;
(ii) an opening in the substantially planar blade shaped to allow passage of seed from a seed delivery device to soil below the substantially planar blade; and
(iii) a vertical element connecting the substantially planar blade to the agricultural row unit, the vertical element shaped to direct soil flow about the furrow opening and seed placement device,
wherein seed is placed in the furrow at the same time the furrow is formed.

7. The agricultural row unit of claim 6, wherein planting depth is an operating depth of the substantially planar blade.

8. The agricultural row unit of claim 7, wherein the coulter operates at a depth below the planting depth.

9. The agricultural row unit of claim 6, wherein the coulter is arranged on the agricultural row unit to cut the soil just in front of the furrow opening and seed placement device.

10. The agricultural row unit of claim 6, wherein where in the furrow opening and seed placement device creates a funnel like soil flow.

11. The agricultural row unit of claim 6, wherein the substantially planar blade is pivotable between ±5° of a horizontal plane.

12. The agricultural row unit of claim 11, wherein the substantially planar blade is pivotable on-the-go.

13. The agricultural row unit of claim 6, wherein the seed delivery device is a conventional delivery tube or an air drive delivery device.

14. A method for planting seed, comprising:
cutting soil with a coulter blade;
drawing a blade through soil to create a furrow, the blade comprising a substantially planar surface, at least one vertical element configured to direct soil flow, and an opening in the substantially planar surface;
creating a soil funnel with the blade; and
inserting a seed into the furrow by causing the seed to exit a seed delivery device, fall through the opening into a center of the soil funnel, and land in the furrow.

15. The method of claim 14, further comprising pivoting the blade at an angle ±5° of a horizontal plane.

16. The method of claim 14, wherein the steps of creating a soil funnel and inserting a seed are executed simultaneously.

17. The method of claim 14, wherein soil fall around the seed while the seed is inserting into the furrow such that the seed does not bounce or roll.

18. The method of claim 14, wherein the soil funnel has a vortical flow.

19. The method of claim 14, wherein the blade is drawn through soil at a desired planting depth.

20. The method of claim 19, wherein the coulter blade cuts the soil at a depth below the desired planting depth.
